(19) United States
(12) Patent Application Publication
(10) Pub. No.: US 2019/0161202 A1
(43) Pub. Date: May 30, 2019

(54) METHOD AND SYSTEM FOR SELECTING AND DISPLAYING AN OPERATING PROTOCOL FOR AN AERIAL VEHICLE

(71) Applicant: GE AVIATION SYSTEMS LIMITED, Cheltenham (GB)

(72) Inventor: Tzvetomir Tzvetkov, Cheltenham (GB)

(21) Appl. No.: 16/174,354

(22) Filed: Oct. 30, 2018

(30) Foreign Application Priority Data
Nov. 24, 2017 (GB) 1719529.8

(51) Int. Cl. B64D 43/00; G01C 23/00; G08G 5/00; G06F 3/14

(52) U.S. Cl. CPC B64D 43/00; G06F 3/14; G08G 5/0039; G01C 23/005

(57) ABSTRACT

A method for selecting and displaying an operating protocol for an aerial vehicle using a multi-layer architecture can include receiving, at one or more computing devices, data indicative of one or more operating parameters of the aerial vehicle. The method can include determining, by the one or more computing devices, the operating state of the aerial vehicle based on the data. The method can include selecting, by the one or more computing devices, an operating protocol based on the determined operating state. The operating protocol can specify one or more executable steps to be performed in response to determining the operating state of the aerial vehicle. In addition, the operating protocol can be selected using a control layer of the multi-layer architecture. The method can include displaying, by the one or more computing devices, the operating protocol on a feedback device viewable by an operator of the aerial vehicle.

### FIELD

The present subject matter relates generally a method and system for selecting and displaying an operating protocol for an aerial vehicle. In particular, the methods and systems can select and display the operating protocol using a multi-layer architecture.

### BACKGROUND

An operator (e.g., pilot) of an aerial vehicle can be presented with large amounts of information in a short period of time. Most often, the information can be provided by instruments and flight displays located within a cockpit of the aerial vehicle. During high workload phases (e.g., emergency situation) of flight, the operator can be presented with more information than can be timely processed. This overload of information presented to the operator can comprise the safety of not only the operator, but also any passengers on board the aerial vehicle.

### BRIEF DESCRIPTION

Aspects and advantages of the present disclosure will be set forth in part in the following description, or may be obvious from the description, or may be learned through practice of the present disclosure.

In one example embodiment, a method for selecting and displaying an operating protocol for an aerial vehicle using a multi-layer architecture can include receiving, at one or more computing devices, data indicative of one or more operating parameters of the aerial vehicle. In addition, the method can include determining, by the one or more computing devices, the operating state of the aerial vehicle based on the data. The method can also include selecting, by the one or more computing devices, an operating protocol based on the determined operating state. In particular, the operating protocol can specify one or more executable steps to be performed in response to determining the operating state of the aerial vehicle. In addition, the operating protocol can be selected using a control layer of the multi-layer architecture. In this way, an operator of the aerial vehicle can be decoupled from selecting the operating protocol. The method can include displaying, by the one or more computing devices, the operating protocol on a feedback device viewable by the operator of the aerial vehicle.

In another example embodiment, a system for selecting and displaying an operating protocol for an aerial vehicle using a multi-layer architecture can include one or more sensors of the aerial vehicle. In addition, the system can include one or more computing devices configured to receive data from the one or more sensors. In particular, the data can be indicative of one or more operating parameters of the aerial vehicle. In addition, the one or more computing devices can be configured to determine the operating state of the aerial vehicle based on the data. The one or more computing devices can also be configured to select an operating protocol based on the determined operating state. In particular, the operating protocol can specify one or more executable steps to be performed in response to determining the operating state. In addition, the operating protocol can be selected using a control layer of the multi-layer architecture so that an operator of the aerial vehicle can be decoupled from selecting the operating protocol. The one or more computing devices can also be configured to display the selected operating protocol on a feedback device viewable by the operator of the aerial vehicle.

In yet another example embodiment, a multi-layer architecture for controlling operating of an aerial vehicle can include an information layer comprising one or more sensors of the aerial vehicle. In addition, the multi-layer architecture can include a control layer. In particular, the control layer can be in communication with the information layer. In addition, the control layer can be configured to determine an operating state of the aerial vehicle based on data from the one or more sensors. The multi-layer architecture can also include a display layer. In particular, the display layer can be in communication with the information layer. In addition, the display layer can be operable to present the operating protocol for viewing by an operator of the aerial vehicle.

These and other features, aspects and advantages of the present disclosure will become better understood with reference to the following description and appended claims. The accompanying drawings, which are incorporated in and constitute a part of this specification, illustrate embodiments of the present disclosure and, together with the description, serve to explain the principles of the present disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended Figs., in which:

FIG. 1 illustrates an aerial vehicle according to example embodiments of the present disclosure;

FIG. 2 illustrates a computing system for an aerial vehicle according to example embodiments of the present disclosure;

FIG. 3 illustrates an flight management system for an aerial vehicle according to example embodiments of the present disclosure;

FIG. 4 illustrates a computing device for implementing one or more aspects according to example embodiments of the present disclosure;

FIG. 5 illustrates a multi-layer architecture for controlling operation of an aerial vehicle according to example embodiments of the present disclosure;

FIG. 6 illustrates a block diagram of a system for selecting and displaying an operating protocol for an aerial vehicle according to example embodiments of the present disclosure;

FIG. 7 illustrates a flow diagram of a method for selecting and displaying an operating protocol for an aerial vehicle according to example embodiments of the present disclosure; and

FIG. 8 illustrates example vehicles according to example embodiments of the present disclosure.

### DETAILED DESCRIPTION

Reference will now be made in detail to present embodiments of the present disclosure, one or more examples of which are illustrated in the accompanying drawings. The detailed description uses numerical and letter designations to refer to features in the drawings.

As used herein, the terms “first” and “second” can be used interchangeably to distinguish one component from another and are not intended to signify location or importance of the individual components. The singular forms “a”, “an”, and “the” include plural references unless the context clearly dictates otherwise.

Example embodiments of the present disclosure are systems and methods directed to selection and display of an operating protocol for an aerial vehicle. In particular, the aerial vehicle can include a multi-layer architecture that can be used to select and display the operating protocol. The multi-layer architecture can include an information layer, a control layer and a display layer. The information layer can include one or more sensors of the aerial vehicle. In this way, the information layer can provide data indicative of one or more operating parameters of the aerial vehicle. The control layer can be communicatively coupled to the information layer. In this way, the control layer can receive data from the information layer. The display layer can be communicatively coupled to the control layer. As will be discussed below in more detail, the control layer can determine an operating state of the aerial vehicle based, at least in part, on the data from the information layer.

In example embodiments, the control layer can include one or more computing device(s). The one or more computing device(s) can be configured to determine the operating state of the aerial vehicle based, at least in part, on the data from the information layer. In an example embodiment, the data can indicate occurrence of a depressurization event within a cockpit of the aerial vehicle. Upon receiving the data, the one or more computing device(s) can determine the aerial vehicle is operating in an emergency state. As will be discussed below in more detail, the control layer can determine an operating protocol for the aerial vehicle based, at least in part, on the operating state of the aerial vehicle.

In example embodiments, the one or more computing device(s) can be configured to select an operating protocol based on the determined operating state of the aerial vehicle. Specifically, the operating protocol can include one or more executable steps that can be displayed on a feedback device viewable by the operator of the aerial vehicle. In addition, the control layer can execute the one or more steps of the operating protocol to adjust operating of the aerial vehicle. In this way, the control layer can cause the aerial vehicle to exit the emergency state.

It should be appreciated that the methods and systems according to example aspects of the present disclosure can have a number of technical effects and benefits. For instance, selecting the operating protocol at the control layer can decouple the operator of the aerial vehicle from selecting the operating protocol. In this way, methods and systems of the present disclosure can simplify and/or reduce the number of mental steps the operator must perform to control operation of the aerial vehicle. This can be especially advantageous during an emergency situation in which the operator is overwhelmed.

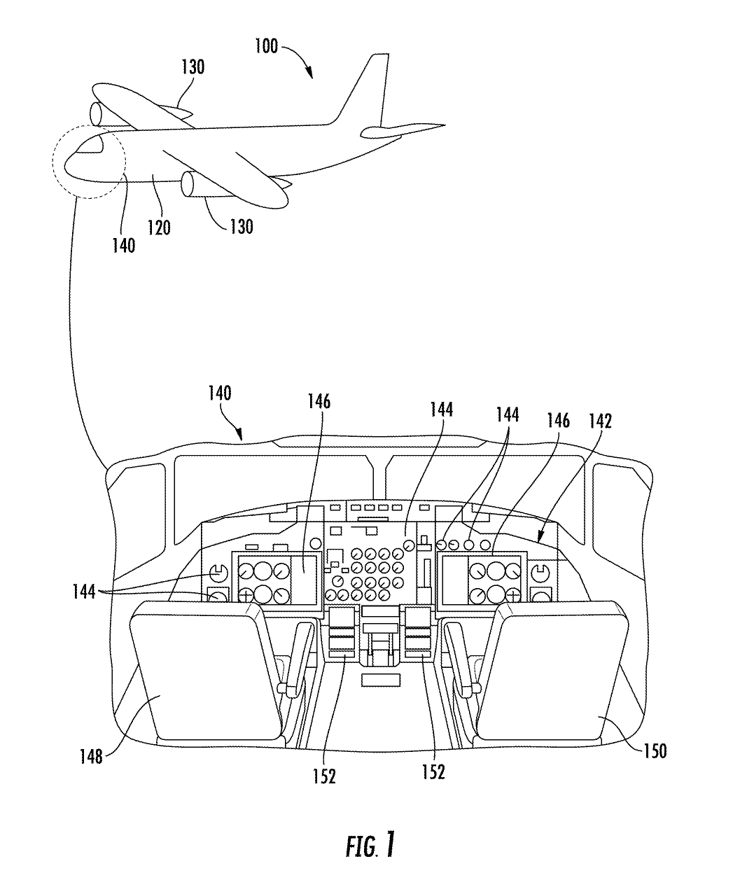

FIG. 1 depicts an aerial vehicle 100 according to example embodiments of the present disclosure. As shown, the aerial vehicle 100 can include a fuselage 120, one or more engine(s) 130, and a cockpit 140. In example embodiments, the cockpit 140 can include a flight deck 142 having various instruments 144 and flight displays 146. It should be appreciated that instruments 144 can include, without limitation, a dial, gauge, or any other suitable analog device.

A first user (e.g., a pilot) can be present in a seat 148 and a second user (e.g., a co-pilot) can be present in a seat 150. The flight deck 142 can be located in front of the pilot and co-pilot and may provide the flight crew (e.g., pilot and co-pilot) with information to aid in operating the aerial vehicle 100. The flight displays 146 can include primary flight displays (PFDs), multi-function displays (MFDs), or both. During operation of the aerial vehicle 100, both the instruments 144 and flight displays 146 can display a wide range of vehicle, flight, navigation, and other information used in the operation and control of the aerial vehicle 100.

The instruments 144 and flight displays 146 may be laid out in any manner including having fewer or more instruments or displays. Further, the flight displays 146 need not be coplanar and need not be the same size. A touch screen display or touch screen surface (not shown) may be included in the flight displays 146 and may be used by one or more flight crew members, including the pilot and co-pilot, to interact with the aerial vehicle 100. The touch screen surface may take any suitable form including that of a liquid crystal display (LCD) and may use various physical or electrical attributes to sense inputs from the flight crew. It is contemplated that the flight displays 146 can be dynamic and that one or more cursor control devices (not shown) and/or one or more multifunction keyboards 152 can be included in the cockpit 140 and may be used by one or more flight crew members to interact with systems of the aerial vehicle 100. In this manner, the flight deck 142 may be considered a user interface between the flight crew and the aerial vehicle 100.

The numbers, locations, and/or orientations of the components of example aerial vehicle 100 are for purposes of illustration and discussion and are not intended to be limiting. As such, those of ordinary skill in the art, using the disclosures provided herein, shall understand that the numbers, locations, and/or orientations of the components of the aerial vehicle 100 can be adjusted without deviating from the scope of the present disclosure.

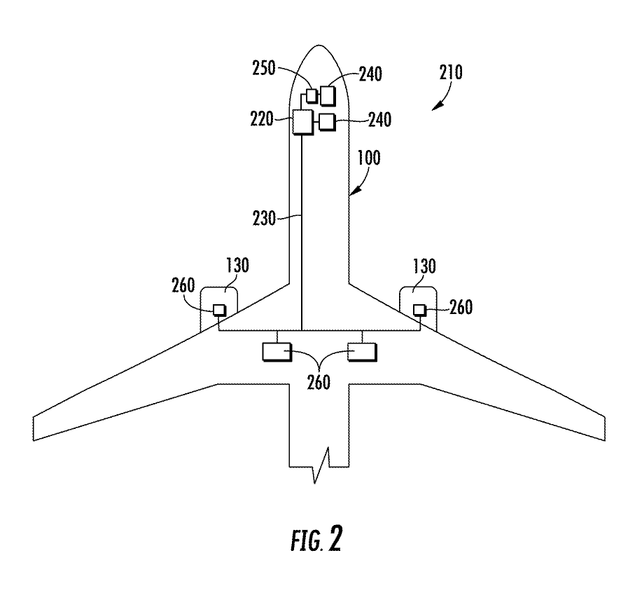

Referring now to FIG. 2, the aerial vehicle 100 can include an onboard computing system 210. As shown, the onboard computing system 210 can include one or more onboard computing device(s) 220 that can be associated with, for instance, an avionics system. In example embodiments, one or more of the onboard computing device(s) 220 can include a flight management system (FMS). Alternatively or additionally, the one or more onboard computing device(s) 220 can be coupled to a variety of systems on the aerial vehicle 100 over a communications network 230. The communications network 230 can include a data bus or combination of wired and/or wireless communication links.

In example embodiments, the onboard computing device(s) 220 can be in communication with a display system 240, such as the flight displays 146 (FIG. 1) within the cockpit 140 of the aerial vehicle 100. More specifically, the display system 240 can include one or more display device(s) that can be configured to display or otherwise provide information generated or received by the onboard computing system 210. In example embodiments, information generated or received by the onboard computing system 210 can be displayed on the one or more display device(s) for viewing by flight crew members of the aerial vehicle 102. The display system 225 can include a primary flight display, a multipurpose control display unit, or other suitable flight displays commonly included within the cockpit 140 (FIG. 1) of the aerial vehicle 100.

The onboard computing device(s) 220 can also be in communication with a flight management computer 250. In example embodiments, the flight management computer 250 can automate the tasks of piloting and tracking the flight plan of the aerial vehicle 100. It should be appreciated that the flight management computer 250 can include or be associated with any suitable number of individual microprocessors, power supplies, storage devices, interface cards, auto flight systems, flight management computers, the flight management system (FMS) and other standard components. The flight management computer 250 can include or cooperate with any number of software programs (e.g., flight management programs) or instructions designed to carry out the various methods, process tasks, calculations, and control/display functions necessary for operation of the aerial vehicle 100. The flight management computer 250 is illustrated as being separate from the onboard computing device(s) 220. However, those of ordinary skill in the art, using the disclosures provided herein, will understand that the flight management computer 250 can also be included with or implemented by the onboard computing device(s) 220.

The onboard computing device(s) 220 can also be in communication with one or more aerial vehicle control system(s) 260. The aerial vehicle control system(s) 260 can be configured to perform various aerial vehicle operations and control various settings and parameters associated with the aerial vehicle 100. For instance, the aerial vehicle control system(s) 260 can be associated with one or more engine(s) 130 and/or other components of the aerial vehicle 100. The aerial vehicle control system(s) 260 can include, for instance, digital control systems, throttle systems, inertial reference systems, flight instrument systems, engine control systems, auxiliary power systems, fuel monitoring systems, engine vibration monitoring systems, communications systems, flap control systems, flight data acquisition systems, a flight management system (FMS), and other systems.

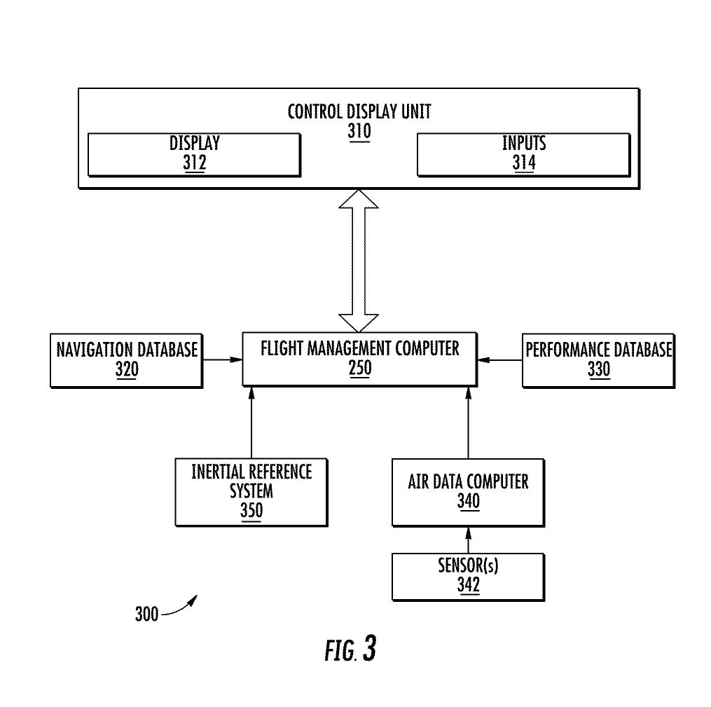

FIG. 3 depicts an example FMS 300 according to example embodiments of the present disclosure. As shown, the FMS 300 can include a control display unit (CDU) 310 having a display 312 and one or more input devices 314 (e.g., keyboard). The CDU 310 can be communicatively coupled to the flight management computer 250. In this way, a flight crew member can communicate information to the flight management computer 250 through manipulation of the one or more input devices 314. Additionally, the flight management computer 250 can communicate information to the flight crew member via the display 312 of the CDU 310.

The FMS 300 can also include a navigation database 320 communicatively coupled to the flight management computer 250. The navigation database 320 can include information from which a flight plan can be generated for the aerial vehicle 100 (FIG. 1). In example embodiments, information stored in the navigation database 320 can include, without limitation, airways and associated waypoints. In particular, an airway can be a predefined path that connects one specified location (e.g., departing airport) to another location (e.g., destination airport). In addition, a waypoint can include one or more intermediate point(s) or place(s) on the predefined path defining the airway.

The FMS 300 can also include a performance database 330 communicatively coupled to the flight management computer 250. The performance database 330 can include information that, in combination with information from the navigation database 320, can be used to generate the flight plan for the aerial vehicle 100 (FIG. 1). In example embodiments, information stored in the performance database 330 can include, without limitation, one or more operating constraint(s) of the aerial vehicle 100. More specifically, the one or more operating constraint(s) can include, without limitation, thrust limits of the one or more engines 130 (FIG. 1) and drag characteristics of the fuselage 120 (FIG. 1).

Example embodiments of the FMS 300 can include an air data computer 340 and an inertial reference system 350. Both the air data computer 340 and the inertial reference system 350 can be communicatively coupled to the flight management computer 250. In example embodiments, the air data computer 340 can determine an altitude and/or airspeed of the aerial vehicle 100. More specifically, the altitude and airspeed of the aerial vehicle 100 can be determined based, at least in part, on data received from one or more sensors 342 of the aerial vehicle 100. Alternatively or additionally, the inertial reference system 350 can include a gyroscope, an accelerometer, or both to determine a position, velocity and/or acceleration of the aerial vehicle 100.

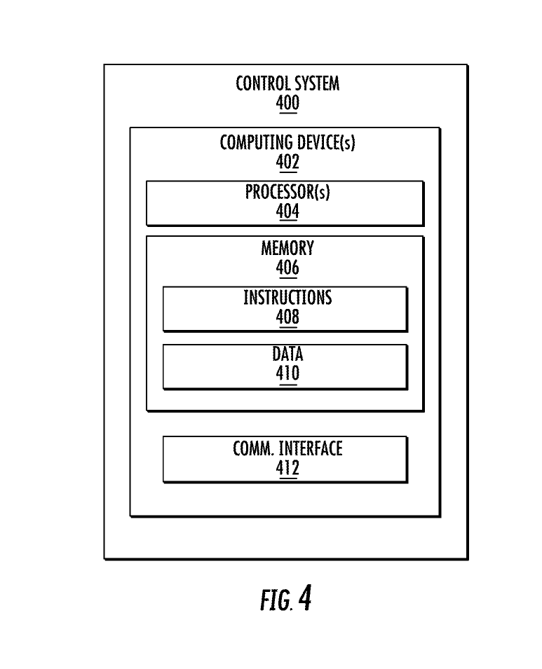

FIG. 4 depicts a block diagram of an example system 400 that can be used to implement methods and systems according to example embodiments of the present disclosure. As shown, the system 400 can include one or more computing device(s) 402. The one or more computing device(s) 402 can include one or more processor(s) 404 and one or more memory device(s) 406. The one or more processor(s) 404 can include any suitable processing device, such as a microprocessor, microcontroller, integrated circuit, logic device, or other suitable processing device. The one or more memory device(s) 406 can include one or more computer-readable media, including, but not limited to, non-transitory computer-readable media, RAM, ROM, hard drives, flash drives, or other memory devices.

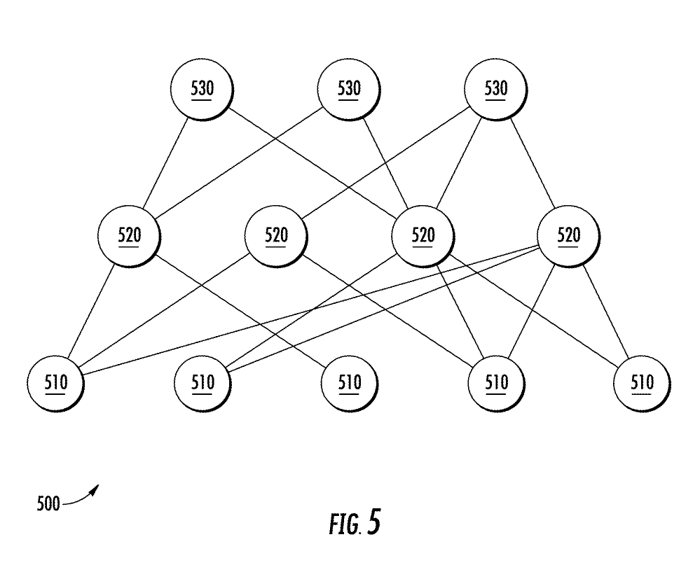

The one or more memory device(s) 406 can store information accessible by the one or more processor(s) 404, including computer-readable instructions 408 that can be executed by the one or more processor(s) 404. The computer-readable instructions 408 can be any set of instructions that when executed by the one or more processor(s) 404, cause the one or more processor(s) 404 to perform operations. The computer-readable instructions 408 can be software written in any suitable programming language or can be implemented in hardware. In some embodiments, the computer-readable instructions 408 can be executed by the one or more processor(s) 404 to cause the one or more processor(s) 404 to perform operations, such as select and display an operating protocol for an aerial vehicle, as described below with reference to FIG. 5.

The memory device(s) 406 can further store data 410 that can be accessed by the one or more processor(s) 404. For example, the data 410 can include any data used for determining an operating state of the aerial vehicle 100, as described herein. In addition, the data 410 can include any data used for selecting an operating protocol for the aerial vehicle, as described herein. It should be appreciated that the data 410 can include one or more table(s), function(s), algorithm(s), model(s), equation(s), etc. for determining an operating state and selecting an operating protocol according to example embodiments of the present disclosure.

The one or more computing device(s) 402 can also include a communication interface 412 used to communicate, for example, with the other components of system. The communication interface 412 can include any suitable components for interfacing with one or more network(s), including for example, transmitters, receivers, ports, controllers, antennas, or other suitable components.

Referring now to FIG. 5, a multi-layer architecture 500 for controlling operation of an aerial vehicle 100 (FIG. 1) is illustrated according to example embodiments of the present disclosure. As shown, the multi-layer architecture 500 can include an information layer 510. In example embodiments, the information layer 510 can include one or more aerial vehicle control systems. More specifically, the information layer 510 can include the FMS 300 (FIG. 3), an engine control system, or both. Alternatively or additionally, the information layer 510 can include one or more sensors of the aerial vehicle 100. In one example embodiment, the information layer 510 can include a sensor operable to sense a pressure within the cockpit 140 (FIG. 1) of the aerial vehicle 100. As such, it should be appreciated that the information layer 510 can encompass systems or sensors operable to provide low level (e.g., raw data) indicative of one or more operating parameters of the aerial vehicle 100.

The multi-layer architecture 500 can also include a control layer 520 communicatively coupled to the information layer 510. In this way, the control layer 520 can receive data from the information layer 510. More specifically, the control layer 520 can receive data indicative of one or more operating parameters of the aerial vehicle 100. In example embodiments, the control layer 520 can be configured to determine an operating state of the aerial vehicle 100 based, at least in part, on the data received from the information layer 510. More specifically, the control layer 520 can include one or more computing device(s) 402 (FIG. 4) configured to determine an operating state of the aerial vehicle 100 based on the data received from the information layer 510. In example embodiments, the one or more computing device 402 can be configured to compare the data to reference data indicative of one or more predefined operating states of the aerial vehicle 100. As such, the one or more computing device(s) 402 can determine the operating state of the aerial vehicle 100 is the predetermined operating state associated with the reference data that most closely matches the data received from information layer 510.

In example embodiments, the control layer 520 can select an operating protocol for the aerial vehicle 100 based, at least in part, on the determined operating state. More specifically, the control layer 520 can include a database configured to store a plurality of predefined operating protocols. The one or more computing device(s) 402 can access the database to match the determined operating state with one of the plurality of predefined operating protocols.

When the control layer 520 selects the operating protocol, it should be appreciated that the operator of the aerial vehicle 100 is decoupled (that is, not involved) in selection of the operating protocol. In this way, the operator can focus on flying the aerial vehicle 100 instead of monitoring the instruments 144 (FIG. 1). This is especially desirable when a single pilot is operating the aerial vehicle 100 during an emergency (e.g., depressurization of cockpit).

Still referring to FIG. 5, the multi-layer architecture 500 can include a display layer 530 communicatively coupled with the control layer 520. In this way, the display layer 530 can receive the operating protocol selected at the control layer 520. In one example embodiment, the display layer 530 can include a feedback device. More specifically, the feedback device can be positioned within the cockpit 140 of the aerial vehicle 100. Alternatively or additionally, the feedback device can be positioned at a ground station (e.g., air traffic control tower). In this way, a remote operator (e.g., air traffic controller) can view the selected operating protocol. As such, the remote operator can approve the selected operating protocol and allow the control layer 520 to control the aerial vehicle 100 in accordance with the selected operating protocol. Alternatively, the remote operator can override the selected operating protocol and manually control the aerial vehicle through manipulation of one or more control devices located at the ground station.

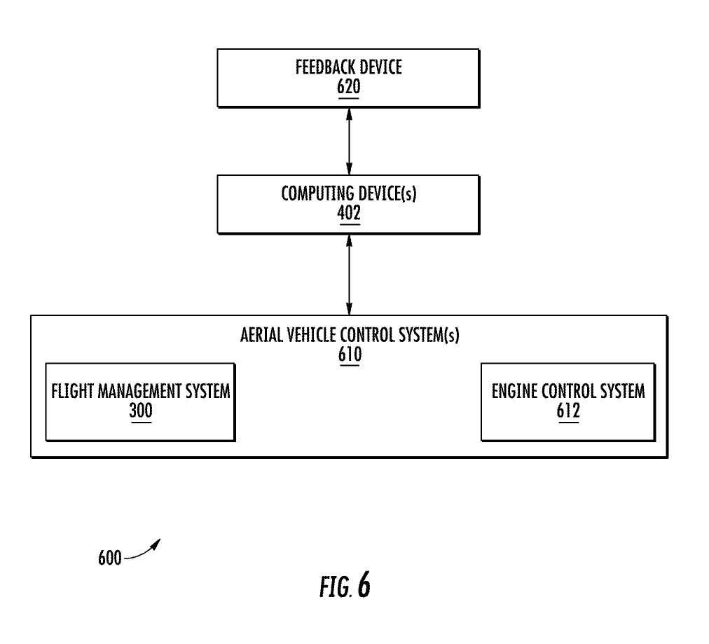

FIG. 6 depicts an example system 600 for selecting and displaying an operating protocol for an aerial vehicle 100 (FIG. 1). More specifically, the system 600 can implement the multi-layer architecture 500 (FIG. 5) to select and display the operating protocol. As shown, the system 600 can include one or more aerial vehicle control system(s) 610 operating within the information layer 510 of the multi-layer architecture 500. More specifically, the one or more aerial vehicle control system(s) 610 can include the FMS 300 (FIG. 3). Alternatively or additionally, the aerial vehicle control system(s) 610 can include an engine control system 612 configured to control operation of the one or more engines 130 (FIG. 1). As will be discussed below in more detail, the one or more aerial vehicle control system(s) 610 can provide data indicative of one or more operating parameters of the aerial vehicle 100.

In one example embodiment, the operating parameter can indicate a position, velocity and/or acceleration of the aerial vehicle 100 along the flight plan generated by the FMS 300. More specifically, the position of the aerial vehicle 100 can be communicated from the inertial reference system 350 (FIG. 3) to the computing device 402 through the flight management computer 250 (FIG. 3). Alternatively, the computing device 402 can be in direct communication with the inertial reference system 350.

In another example embodiment, the operating parameter can indicate an engine torque Q of the one or more engine(s) 130 (FIG. 1) generating thrust for the aerial vehicle 100. Alternatively or additionally, the operating parameter can indicate a temperature within a turbine section of the one or more engine(s) 130. It should be appreciated, however, that data received from the engine control system 512 can be any suitable operating parameter indicative of performance of the one or more engine(s) 130.

In yet another example embodiment, the operating parameter can be a pressure reading from a sensor (not shown) operable to measure a pressure within the cockpit 140 (FIG. 1) of the aerial vehicle 100. It should be appreciated, however, that the sensor can be located at any suitable location within the aerial vehicle 100. For example, if the aerial vehicle 100 is an airliner, the sensor can be positioned within a passenger cabin. In this way, the sensor can sense a pressure within the passenger cabin. As will be discussed below in more detail, the data received from the one or more aerial vehicle control system(s) 610 can be used to determine an operating state of the aerial vehicle 100.

As shown, the system 600 can include the computing device 402 described above with reference to FIG. 4. In example embodiments, the computing device 402 can operate within the control layer 520 (FIG. 5) of the multi-layer architecture 500. As such, the computing device 402 can be communicatively coupled with the one or more aerial vehicle control system(s) 610. In this way, the computing device 402 can receive data from the FMS 300, the engine control system 512, one or more sensors of the aerial vehicle 100, or any combination thereof. As will be discussed below in more detail, the computing device 402 can be configured to determine an operating state of the aerial vehicle 100 (FIG. 1) based, at least in part, on the data received from the one or more aerial control system(s) 610.

In example embodiments, a sensor within the cockpit 140 can sense a pressure indicative of a depressurization event. More specifically, the sensor can sense the pressure within the cockpit 140 dropping to an unsafe level that can cause the pilot to become unconscious. When the pressure within the cockpit 140 is at the unsafe level, the aerial vehicle 100 can be considered unmanned, and the computing device 402 can determine the aerial vehicle 100 is operating in an emergency state. As will be discussed below in more detail, the computing device 402 can be configured to select an operating protocol for the aerial vehicle 100 based on the operating state of the aerial vehicle 100.

In example embodiments, the computing device 402 can select an operating protocol based on the emergency state of the aerial vehicle 100. In particular, the operating protocol can be specified by one or more executable steps to be performed in response to the determined operating state of the aerial vehicle 100. In one example embodiment, the computing device 402 can perform the one or more executable steps of the operating protocol.

The computing device 402 can also be configured to display the operating protocol on a feedback device 620 viewable by an operator of the aerial vehicle 100. More specifically, the feedback device 620 can be positioned within the cockpit 140 of the aerial vehicle 100. For example, the feedback device 620 can be one of the flight displays 146 (FIG. 1) of the flight deck 142. Alternatively, the feedback device 620 can be positioned at a ground station (e.g., air traffic control tower). As will be discussed below in more detail, the computing device 402 can be configured to execute the one or more executable steps of the operating protocol to cause the aerial vehicle 100 to exit the emergency state.

In one example embodiment, the one or more executable steps of the selected operating protocol, when executed, can cause the computing device 402 to determine an airport located within a predetermined proximity of the aerial vehicle 100. More specifically, the computing device 402 can command the FMS 300 to determine the airport. In addition, the computing device 402 can update the flight plan for the aerial vehicle 100 so that the updated flight plan directs the aerial vehicle 100 to a runway at the airport. More specifically, the computing device 402 can command the FMS 300 to update the flight plan. The computing device 402 can also be configured to display the updated flight plan on the feedback device 620.

The computing device 402 can be configured to execute the updated flight plan. More specifically, the computing device 402 can command the FMS 300 to execute the updated flight plan. In this way, the computing device 402 can safely land the aerial vehicle 100 at the airport so that the pilot as well as any passengers on board can receive medical attention. In some example embodiments, the computing device 402 can be configured to execute the updated flight plan after a predetermined amount of time has lapsed since displaying the updated flight plan on the feedback device 520. In this way, the pilot, if conscious, can override the updated flight plan and manually control operation of the aerial vehicle 100. Alternatively, the computing device 402 can be configured to execute the updated flight plan immediately after displaying the updated flight plan on the feedback device 620.

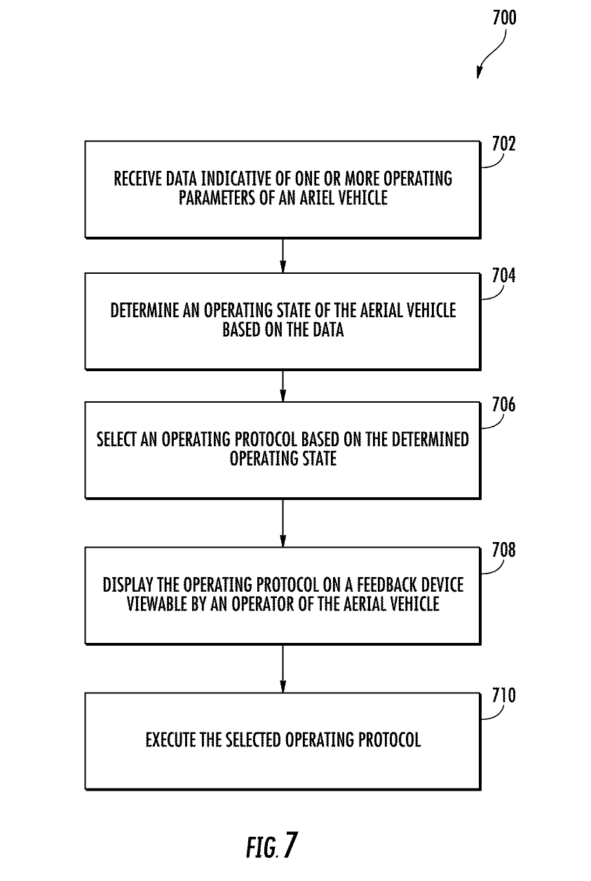

FIG. 7 depicts a flow diagram of an example method 700 for selecting and displaying an operating protocol for an aerial vehicle. The method 700 can be implemented using, for instance, the multi-layer architecture 500 and system 600 described above with reference to FIGS. 5 and 6. FIG. 7 depicts steps performed in a particular order for purposes of illustration and discussion. Those of ordinary skill in the art, using the disclosures provided herein, will understand that various steps of any of the methods disclosed herein can be adapted, modified, rearranged, performed simultaneously or modified in various ways without deviating from the scope of the present disclosure.

At (702), the method 700 can include receiving, by one or more computing device(s), data indicative of one or more operating parameters of an aerial vehicle. Specifically, in example embodiments, the data can be received from one or more aerial control system(s) of the aerial vehicle. Alternatively, the data can be received from any suitable sensor of the aerial vehicle. In one example embodiment, the data can be received from a sensor located within a cockpit of the aerial vehicle. More specifically, the sensor can sense a pressure within the cockpit. In this way, the one or more computing device(s) can determine occurrence of a depressurization event within the cockpit based, at least in part, on data received from the sensor.

At (704), the method 700 can include determining, by the one or more computing device(s), an operating state of the aerial vehicle based on the data received at (702). More specifically, the one or more computing device(s) can be configured to compare the data to reference data indicative of one or more predefined states (e.g., emergency state). In example embodiments, the one or more computing device(s) can determine the aerial vehicle is operating in an emergency state based, at least in part, on the data received from the sensor within the cockpit.

At (706), the method 700 can include selecting, by the one or more computing device(s), an operating protocol based on the operating state determined at (704). More specifically, the one or more computing device(s) can match the operating state determined at (704) with one of a plurality of predefined operating protocols. In example embodiments, the one or more computing device(s) can select an operating protocol based on the determined emergency state of the aerial vehicle.

At (708), the method 700 can include displaying, by the one or more computing device(s), the operating protocol on a feedback device viewable by an operator (e.g., pilot) of the aerial vehicle. In one example embodiment, the feedback device can be disposed within a cockpit of the aerial vehicle. Alternatively, the feedback device can be disposed at a ground station (e.g., air traffic control tower).

At (710), the method 700 can include executing, by the one or more computing device(s), the selected operating protocol to adjust operation of the aerial vehicle. In example embodiments, the operating protocol selected at (706) can, when executed, cause the one or more computing device(s) to determine an airport within a predetermined proximity of the aerial vehicle. In addition, one or more computing device(s) can update the flight plan so that the updated flight plan directs the aerial vehicle to a runway at the airport. The one or more computing device(s) can also display the updated flight plan on the feedback device. In addition, the one or more computing device(s) can execute the updated flight plan and safely land the aerial vehicle at the airport. In this way, the pilot as well as any passengers onboard can receive medical attention.

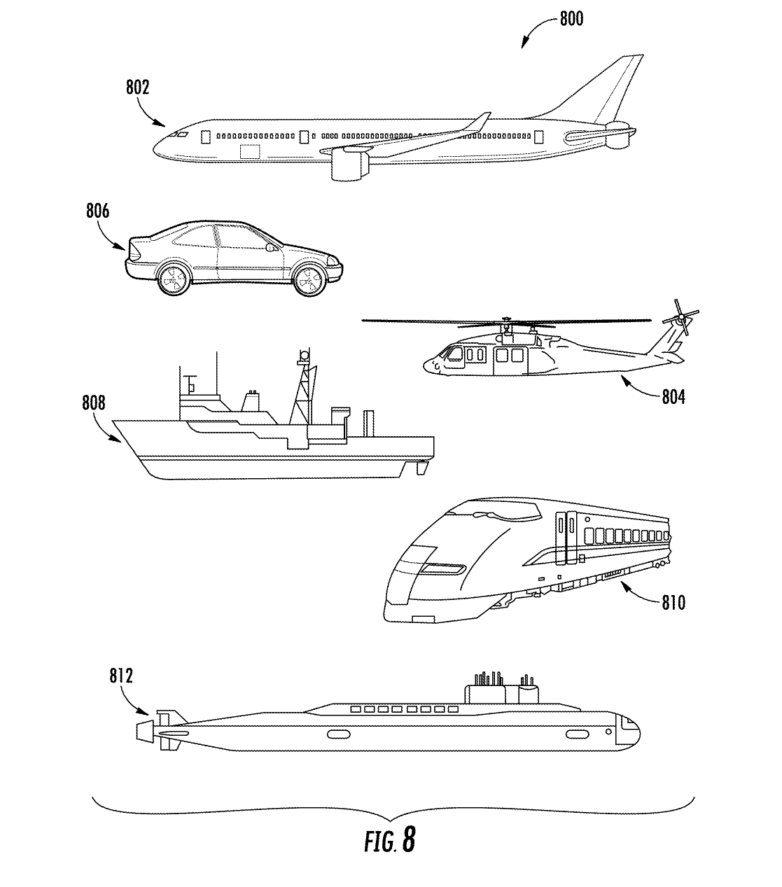

Referring now to FIG. 8, example vehicles 800 according to example embodiments of the present disclosure are depicted. The systems and methods of the present disclosure can be implemented on an aerial vehicle 802, helicopter 804, automobile 806, boat 808, train 810, submarine 812 and/or any other suitable vehicles. One of ordinary skill in the art would understand that the systems and methods of the present disclosure can be implemented on other vehicles without deviating from the scope of the present disclosure.

Although specific features of various embodiments may be shown in some drawings and not in others, this is for convenience only. In accordance with the principles of the present disclosure, any feature of a drawing may be referenced and/or claimed in combination with any feature of any other drawing.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

This written description uses examples to disclose example embodiments of the present disclosure, including making and using any devices or systems and performing any incorporated methods. The patentable scope of the present disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for selecting and displaying an operating protocol for an aerial vehicle using a multi-layer architecture, comprising:
receiving, at one or more computing devices, data indicative of one or more operating parameters of the aerial vehicle;
determining, by the one or more computing devices, the operating state of the aerial vehicle based on the data;
selecting, by the one or more computing devices, an operating protocol based on the determined operating state, the operating protocol specifying one or more executable steps to be performed in response to determining the operating state; and
displaying, by the one or more computing devices, the operating protocol on a feedback device viewable by an operator of the aerial vehicle,
wherein the operating protocol is selected using a control layer of the multi-layer architecture that decouples the operator from selecting the operating protocol.

2. The method of claim 1, further comprising executing, by the one or more computing devices, the one or more executable steps of the selected operating protocol to adjust operation of the aerial vehicle.

3. The method of claim 2, wherein executing the one or more executable steps of the selected operating protocol occurs only after a predetermined amount of time has lapsed since displaying the protocol on the feedback device.

4. The method of claim 2, wherein executing the one or more steps of the selected operating protocol occurs immediately after displaying the protocol on the feedback device.

5. The method of claim 1, wherein determining the operating state comprises comparing, by the one or more computing devices, the data to reference data indicative of one or more predefined operating states of the aerial vehicle.

6. The method of claim 1, wherein selecting the operating protocol comprises matching, by the one or more computing devices, the determined operating state with one of a plurality of predefined operating protocols.

7. A system for selecting and displaying an operating protocol for an aerial vehicle using a multi-layer architecture, the system comprising:
one or more sensors of the aerial vehicle; and
one or more computing devices configured to:
receive data from the one or more sensors, the data indicative of one or more operating parameters of the aerial vehicle;
determine the operating state of the aerial vehicle based on the data;
select an operating protocol based on the determined operating state, the operating protocol specifying one or more executable steps to be performed in response to determining the operating state; and
display the selected operating protocol on a feedback device viewable by an operator of the aerial vehicle,
wherein the operating protocol is selected using a control layer of the multi-layer architecture that decouples the operator from selecting the operating protocol.

8. The system of claim 7, wherein the one or more computing devices are further configured execute the one or more steps of the selected operating protocol to adjust operation of the aerial vehicle.

9. The system of claim 8, wherein the one or more computing devices are configured to execute the one or more steps of the selected operating protocol only after a predetermined amount of time has lapsed since displaying the protocol on the feedback device.

10. The system of claim 8, wherein the one or more computing devices are configured to execute the one or more steps of the selected operating protocol immediately after the selected operating protocol is displayed on the feedback device.

11. The system of claim 8, wherein the data from the one or more sensors indicate occurrence of a depressurization event within a cockpit of the aerial vehicle, and wherein the determined operating state corresponds to an emergency state.

12. The system of claim 11, wherein when executing the one or more executable selected operating protocol, the one or more computing devices are configured to:
determine an airport within a predetermined proximity of the aerial vehicle; and
update a flight plan for the aerial vehicle,
wherein the updated flight plan directs the aerial vehicle to land at the airport.

13. The system of claim 12, wherein the one or more computing devices are configured to display the updated flight plan on the feedback device.

14. The system of claim 12, wherein the one or more computing devices are configured to execute the updated flight plan so that the aerial vehicle lands at the airport.

15. The system of claim 14, wherein the one or more computing devices are configured to execute the updated flight plan only after a predetermined amount of time has lapsed since displaying the updated flight plan on the feedback device.

16. The system of claim 14, wherein the one or more computing devices are configured to execute the updated flight plan immediately after the flight plan is updated.

17. The system of claim 7, wherein the feedback device is positioned within a cockpit of the aircraft or a ground station at a remote location.

18. A multi-layer architecture for controlling operation of an aerial vehicle, comprising:
an information layer comprising one or more sensors of the aerial vehicle;
a control layer in communication with the information layer, the control layer configured to determine an operating state of the aerial vehicle based on data from the one or more sensors, the control layer further configured to determine an operating protocol for the aerial vehicle based on the determined operating state; and
a display layer in communication with the control layer, the display layer operable to present the operating protocol for viewing by an operator of the aerial vehicle.

19. The architecture of claim 18, wherein the display layer comprises a feedback device positioned within a cockpit of the aerial vehicle or a ground station at a remote location.
